(19) United States
(12) Patent Application Publication
(10) Pub. No.: US 2015/0192360 A1
(43) Pub. Date: Jul. 9, 2015

(54) METHOD AND DEVICE FOR DRYING A FLUID FILM APPLIED TO A SUBSTRATE

(71) Applicant: FMP TECHNOLOGY GmbH FLUID MEASUREMENT & PROJECTS, Erlangen (DE)

(72) Inventor: Franz Durst, Langensendelbach (DE)

(21) Appl. No.: 14/409,863

(22) PCT Filed: Jan. 25, 2013
(86) PCT No.: PCT/EP2013/051476

§ 371 Date: Dec. 19, 2014

(30) Foreign Application Priority Data
Jun. 20, 2012 (DE) 10 2012 210 431.3

(51) Int. Cl. F26B 13/10; F26B 3/20

(52) U.S. Cl. CPC F26B 13/10; F26B 3/20

(57) ABSTRACT

The invention relates to a method for drying a fluid film including a vaporizable liquid and applied to a substrate surface of a substrate, having the following steps: transporting of the substrate on a transport surface of a transport device along a transport direction via a drying apparatus, vaporizing the liquid by means of a plurality of heat sources arranged in succession in the transport direction, wherein each of the heat sources has a heating surface which is arranged at a distance of 0.1 mm to 15.0 mm opposite the substrate surface, and discharging of the vaporized liquid through a discharge opening between two successive heating surfaces.

The invention relates to a method and a device for drying a fluid film applied to a substrate, said fluid film containing a vaporisable liquid.

According to the prior art, it is known to coat the surfaces of web materials. The web materials may be, for example, paper, plastics films, textiles or metal strips. In order to coat the surface, a fluid film is applied, which contains a vaporisable liquid and non-vaporisable components. The fluid film is solidified by vaporisation of the vaporisable liquid. This process is referred to as drying of the fluid layer.

For solidification or drying of the fluid film, it is known for example from DE 39 27 627 A1 to expose both an underside of the substrate and an opposed upper side, provided with the fluid film, to a flow of a heated transport gas. In order to direct such a flow onto the upper side, first and second filter plates arranged in succession in the transport direction are provided. Supply air is fed by the first filter plates. The exhaust air, enriched with vapours and solvents, is discharged by the second filter plates. The provision of the filter plates contributes to a relatively slow flow velocity, such that the supply air and exhaust air flows substantially in a laminar manner. Signs of flecks on the surface of the fluid film can thus be avoided.

It is known from WO 82/03450 to feed supply air by means of a distributor plate provided at a distance above the fluid film. Due to the effect of the distributor plate, the flow of the transport gas is decelerated in the region above the fluid layer. Turbulent flows are avoided. A liquid vapour escaping from the fluid film, however, cannot be discharged particularly quickly. This drying method is not particularly efficient.

In the case of the drying methods known in accordance with the prior art, large volume flows of transport gas are required, which then have to be purified and/or regenerated in a complex manner.

One object of the invention is to overcome the disadvantages according to the prior art. In particular, a method and a device are to be specified, with which a fluid film applied to a substrate can be dried whilst avoiding signs of flecks and with improved energy efficiency. In accordance with a further object of the invention, a quantity of transport gas necessary to discharge the vaporised liquid is to be kept as small as possible.

These objects are achieved by the features of claims 1 and 19. Expedient embodiments of the invention will emerge from the features of claims 2 to 18 and 20 to 35.

In accordance with the invention, a method for drying a fluid film applied to a substrate surface of a substrate, the fluid film containing a vaporisable liquid is proposed, said method comprising the following steps:

transporting the substrate on a transport surface of a transport device along a transport direction through a drying assembly,
vaporising the liquid by means of a number of heat sources arranged in succession in the transport direction, wherein each of the heat sources has a heating surface, which is arranged at a distance from 0.1 mm to 15.0 mm opposite the substrate surface, and
discharging the vaporised liquid by a first discharge opening provided between two successive heating surfaces.

In the case of the proposed method, in contrast to the prior art, the liquid is vaporised by means of a heat source provided opposite the substrate. Since the heating surface of the heat source is arranged merely at a distance from 0.1 mm to 15.0 mm opposite the substrate surface, the heat in the method according to the invention is fed to the fluid film substantially by direct heat conduction. As a result, the fluid film is advantageously heated in the direction of the substrate surface, starting from the boundary surface of the fluid film facing the heating surface. In contrast to the input of heat by means of heat radiation, where said heat is absorbed substantially at the substrate surface, a particularly effective and uniform vaporisation of the liquid can be achieved by the method according to the invention.

In accordance with a further concept of the invention, the heat is input onto the substrate by means of a plurality of heating surfaces arranged in succession in the transport direction, wherein a first discharge opening for discharging the vaporised liquid is provided between two successive heat surfaces. Thus it is possible to discharge the vaporised liquid or a transport gas absorbing the vaporising liquid particularly quickly from a drying channel, which is formed by the heating surfaces, the transport surface and also side walls running in the transport direction. With the method proposed in accordance with the invention, drying rates of up to 20 g/m²s can be achieved. This corresponds to approximately 10 times the drying rates that can be achieved with the methods known in accordance with the prior at. The required quantities of transport gas can be reduced by a factor of up to 100. The outlay for heating and purifying the transport gas can be considerably reduced. The proposed method enables a particularly efficient drying of a fluid film applied to a substrate surface of a substrate.

In accordance with an advantageous embodiment of the invention, it is proposed for the transport gas to be fed through a feed opening provided between two successive heating surfaces. The transport gas is advantageously discharged and fed alternately in the transport direction by alternately arranged discharge and feed openings.

The feed openings are formed in particular such that the transport gas is thus fed to the drying channel in a direction substantially parallel to the transport direction. The formation of a laminar flow in the drying channel can thus be assisted. The feed openings are advantageously formed such that a flow directed therewith to the first slots runs in the transport direction. However, the feed openings can also be formed such that a flow directed against the transport direction is formed from the feed openings to the discharge openings.

A distance between the discharge and the feed openings is advantageously 20 to 100 mm, preferably 40 to 70 mm.

The transport gas can be fed through the feed openings at a rate from 1 to 10 m/s. It can be discharged through the discharge openings at a further rate from 1 to 10 m/s.

In accordance with a further advantageous embodiment of the invention, the transport gas, prior to being fed, is heated to a temperature from 50° C. to 300° C., preferably 100° C. to 250° C. The relative humidity of the transport gas can be less than 50%, advantageously less than 30%. For this purpose, the transport gas is advantageously dried prior to being fed to the feed opening. The transport gas is expediently only heated following the drying.

In accordance with an advantageous embodiment, a first temperature T_{G} of the heating surface is controlled depending on a boundary surface temperature T_{I} of the fluid film. Here, the first temperature T_{G} is set such that the necessary transport of the released fluid vapour away from the surface is ensured.

The heat is advantageously transferred from the heating surface to the fluid film substantially by means of direct heat conduction. Due to the short distance between heating surface and boundary surface of the fluid film and due to the arrangement of the heating surface above the boundary surface, there is hardly any convection in the transport gas. Equally, the heat contained in the transport gas by molecule movement is transferred to the fluid film similarly to “direct heat transfer”. The heat radiation irradiated from the heating surface is absorbed substantially by the substrate and/or the transport surface. It is transferred from there to the fluid film.

The first temperature T_{G} is expediently controlled in the range from 50° C. to 200° C., preferably in the range of 80° C. and 150° C.

In accordance with a further advantageous embodiment, the transport surface is heated by means of a further heat source. A second temperature T_{H} of the transport surface generated by the further heat source is advantageously controlled depending on the boundary surface temperature T_{I}. Here, the second temperature T_{H} can be controlled in particular such that the following relationship is satisfied:

T_{H}=T_{I}+ΔT, wherein

T_{I} is in the range from 10° C. to 50° C. and
ΔT is in the range from 10° C. to 40° C., preferably 20° C. to 30° C.

Due to the vaporisation of the liquid, the transport surface is cooled. In order to increase the mass flow of the vaporised liquid, the transport surface is heated to a second temperature T_{H} by means of a further heat source. Here, the second temperature T_{H} is set such that it is greater than the boundary surface temperature T_{I}. A particularly high mass flow of the vaporised liquid is then advantageously achieved when the difference ΔT between the boundary surface temperature T_{I} and the second temperature T_{H} lies in the range from 2° C. to 30° C.

Air or a non-combustible gas can be used as transport gas. The vaporisation of the liquid is expediently carried out in a non-combustible gas atmosphere, preferably a nitrogen or carbon dioxide atmosphere. An ignition of a combustible liquid vaporised within the drying assembly can thus be avoided securely and reliably.

In accordance with a further particularly advantageous embodiment, the heating surface facing the substrate is arranged at a distance from 0.2 mm to 10.0 mm, preferably 0.2 to 5.0 mm, opposite the substrate surface. The proposed short distance between the heating surface and the substrate surface enables a particularly homogeneous heating of the fluid film and therefore a uniform vaporisation of the liquid. Here, a thickness of the fluid film is of course selected such that it is smaller than the aforementioned distance. By way of example, the fluid film may have a thickness in the range from 5 μm to 300 μm, preferably 10 μm to 100 μm.

In accordance with a further advantageous embodiment, the second temperature T_{H} is controlled such that it is always less than the first temperature T_{G}. A temperature difference between the first T_{G} and the second temperature T_{H} can be controlled in particular such that a predefined temperature difference profile is set along the transport direction. The temperature gradient or the temperature difference between the first temperature T_{G} and second temperature T_{H} can change along the transport direction in a predefined manner. The fact that the quantity of the liquid to be vaporised decreases in the transport direction is thus taken into consideration. The change of the temperature gradient can be caused by a suitable control of the first temperature T_{G} and/or second temperature T_{H} or also by a change of the distance of the heating surface from the boundary surface.

An electric heating source, preferably a heating source equipped with resistance heating elements, is expediently used as heat source. Here, the resistance heating elements for example can be arranged in a grid-like manner. It is also possible to use at least one heat exchanger as heat source. Such a heat exchanger can be formed such that a liquid can flow through, similarly to a radiator for motor vehicles. A plurality of heat exchangers can also be provided in the transport direction one after the other, wherein a gap can be provided between each of the heat exchangers. Due to the gaps, the vaporised liquid can be discharged from the surface of the fluid film.

In accordance with a further advantageous embodiment of the invention, at least one rotatable drum is used as a transport device, the outer lateral surface of said drum forming the transport surface. Such a transport device can be formed in a relatively compact manner. It may also be combined with a slot die tool for applying the fluid film. In the case of the use of a rotatable drum as transport device, the heat source is formed in a manner corresponding to the outer lateral surface of the drum, that is to say the heating surfaces are arranged at a predefined short distance from the outer lateral surface. The further heat source is arranged for example within the drum. By means of the further heat source, the transport surface is heated from an underside of the transport device opposite the substrate, preferably by means of direct heat conduction. By way of example, the transport surface can be electrically heated by means of resistance heating elements. Such an electric heating enables a particularly simple control of the temperature of the transport surface.

In accordance with a further stipulation of the invention, a device for drying a fluid film applied to a substrate surface of a substrate, the fluid film containing a vaporisable liquid is proposed, said device comprising:

a transport device for transporting the substrate on a transport surface along a transport direction,
a plurality of heat sources arranged opposite the substrate in succession in the transport direction, wherein each of the heat sources has a heating surface which is arranged opposite the substrate surface at a distance from 0.1 mm to 15.0 mm, and,
an assembly for discharging the vaporised liquid, said assembly comprising a discharge opening provided between two successive heating surfaces in order to discharge the vaporised liquid.

The proposed device enables an efficient drying of a fluid film applied to a substrate. Here, the liquid is vaporised by a number of heat sources provided opposite substrate. The heating surfaces of the heat sources are arranged, in contrast to the prior art, merely at a distance from 0.1 to 15.0 mm, preferably 0.2 to 10.0 mm, from the substrate surface. A discharge opening is provided between two successive heating surfaces. The discharge opening is part of an assembly for discharging the vaporised liquid. It is thus possible to discharge the vaporised liquid quickly from the drying channel. The proposed device enables an efficient drying of a fluid film applied to a substrate surface of a substrate.

In accordance with an advantageous embodiment of the invention, an assembly for feeding transport gas is provided, said assembly comprising a feed opening provided between two successive heating surfaces in order to feed the transport gas. The discharge and the feed openings are advantageously provided alternately between the heating surfaces arranged in succession in the transport direction. A distance between the discharge and the feed openings is for example 10 mm to 100 mm, preferably 30 mm to 70 mm. The proposed alternate arrangement of the discharge and feed openings enables an efficient discharge of the vaporised liquid.

In accordance with a further advantageous embodiment, the transport gas is fed through the feed openings at a rate from 1 to 10 m/s by means of the feeding assembly. Here, the feed openings are expediently formed such that the transport gas is fed to the drying channel in a direction running substantially parallel to the transport direction. The transport gas can be fed to the drying channel both in the transport direction and against the transport direction.

A heater for heating the transport gas to a temperature from 150° C. to 300° C., preferably 100° C. to 250°, can be provided. The assembly for heating the transport gas can be combined with an assembly for drying the transport gas. Due to the short distance between the heating surfaces and the substrate proposed in accordance with the invention, only a small quantity of transport gas is required. The heater and an optionally provided drying device can be formed smaller and more cost effectively compared with the devices known in accordance with the prior art.

In accordance with a particularly advantageous embodiment of the invention, the discharging assembly is formed from a plurality of modules arranged in succession in the transport direction, wherein each of the modules has two heating surfaces and an interposed discharge opening, which, based on a flow direction of the discharged transport gas, is arranged upstream of a discharge channel. The modular design enables a simple and efficient production of devices with drying assemblies of different length in the transport direction. Furthermore, the proposed device can be easily repaired. By way of example, in the case of a failure of a heating surface, the module in question can be quickly and easily replaced.

Two successive modules are advantageously arranged such that the feed opening is formed therebetween. For this purpose, corresponding spacers and/or a connection device can be provided on the module, said connection device enabling a connection of two successive modules, thus forming the feed opening.

In accordance with a further advantageous embodiment, a feed channel and a fan for feeding the transport gas are provided upstream of the feed opening, based on the flow direction of the fed transport gas. All feed openings are expediently connected to a common feed channel.

In accordance with an advantageous embodiment, a further heat source for heating the transport surface is provided. The further heat source is expediently provided on an “underside” of the transport device opposite the substrate. For example, this further heat source may be a resistance heater.

In accordance with a further advantageous embodiment, a first control assembly for controlling a first temperature T_{G} produced by the heating surface depending on a boundary surface temperature T_{I} of the fluid film is provided. The control variable, specifically the first temperature T_{G} of the heating surface, is set in accordance with a predefined algorithm depending on the boundary surface temperature T_{I}, which forms the reference variable. Here, the first temperature T_{G} can be controlled for example such that a predefined temperature gradient is formed between the boundary surface temperature T_{I} and the first temperature T_{G}.

Furthermore, a second control assembly for controlling a second temperature T_{H} of the transport surface depending on the boundary surface temperature T_{I} is advantageously provided. In this case, the boundary surface temperature T_{I} is measured as a reference variable. Depending on the measured boundary surface temperature T_{I}, the second temperature T_{H} is set or updated by means of the control assembly. Here, the second temperature T_{H} is expediently set or updated in such a way that a predefined boundary surface temperature T_{I} is kept substantially constant.

The first T_{G} and the second temperature T_{H} can be measured for example by means of conventional thermocouples. The boundary surface temperature T_{I} can be detected contactlessly, for example by means of an infrared measuring unit.

The first control assembly can also be omitted. In this case, the first temperature T_{G} is kept constant. The first and the second control assembly can also be coupled. A temperature gradient between the first temperature T_{G} and the second temperature T_{H} can be controlled in accordance with a further predefined algorithm, such that a predefined temperature difference profile between the transport surface and the heating surface is set along the transport direction.

With regard to the advantageous embodiment of the device, reference is made to the description of the embodiments of the method. The embodiment features described with regard to the method also form embodiments of the device correspondingly.

The invention will be explained in greater detail hereinafter on the basis of the drawings, in which:

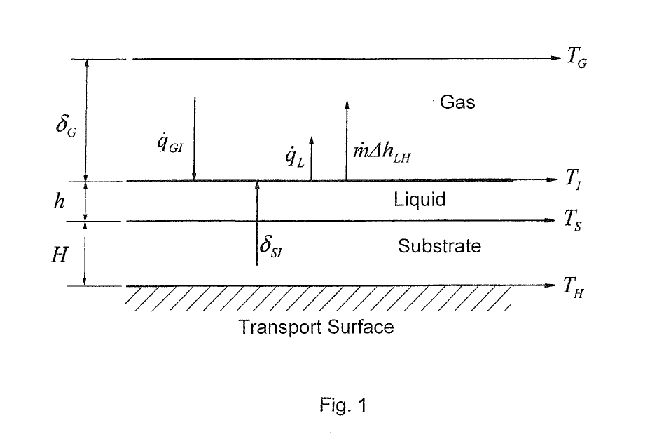

FIG. 1 shows a schematic illustration for explaining the variables used in the formulas,

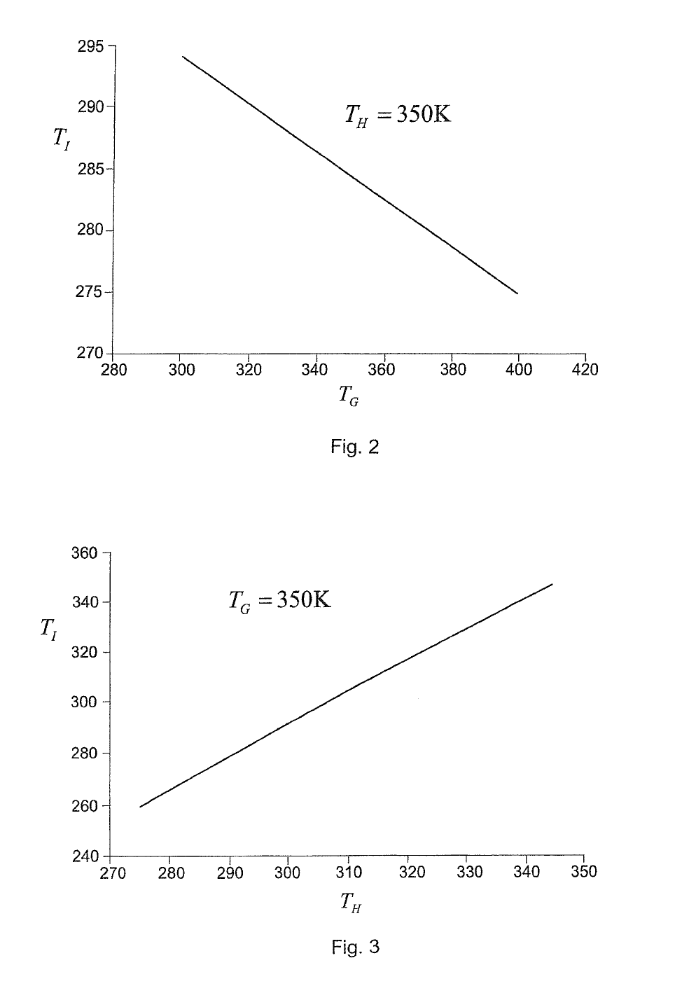

FIG. 2 shows the boundary surface temperature over the gas temperature at predefined transport surface temperature,

FIG. 3 shows the boundary surface temperature over the transport surface temperature at predefined gas temperature,

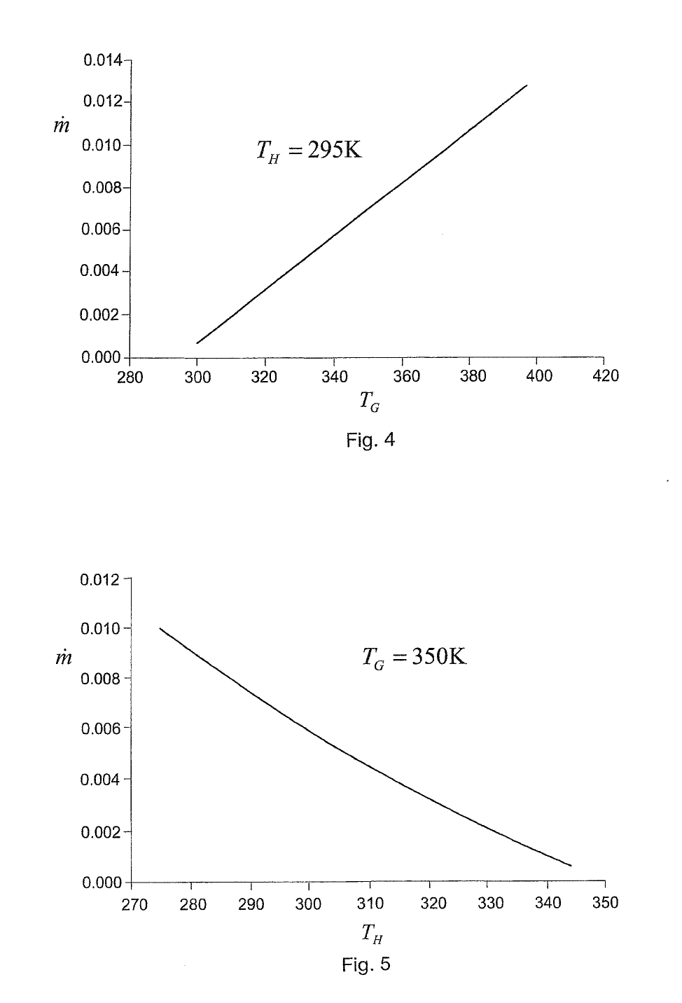

FIG. 4 shows the mass diffusion rate over gas temperature at predefined transport surface temperature,

FIG. 5 shows the mass diffusion rate over transport surface temperature at predefined gas temperature,

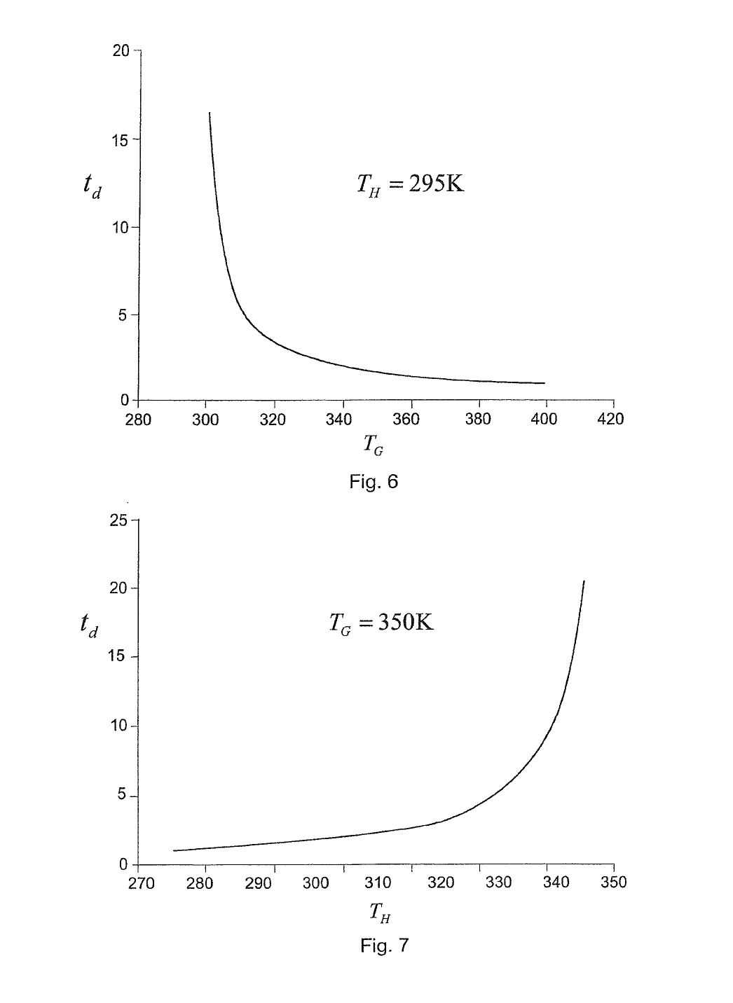

FIG. 6 shows the drying period over gas temperature at predefined transport surface temperature,

FIG. 7 shows the drying period over transport surface temperature at predefined gas temperature,

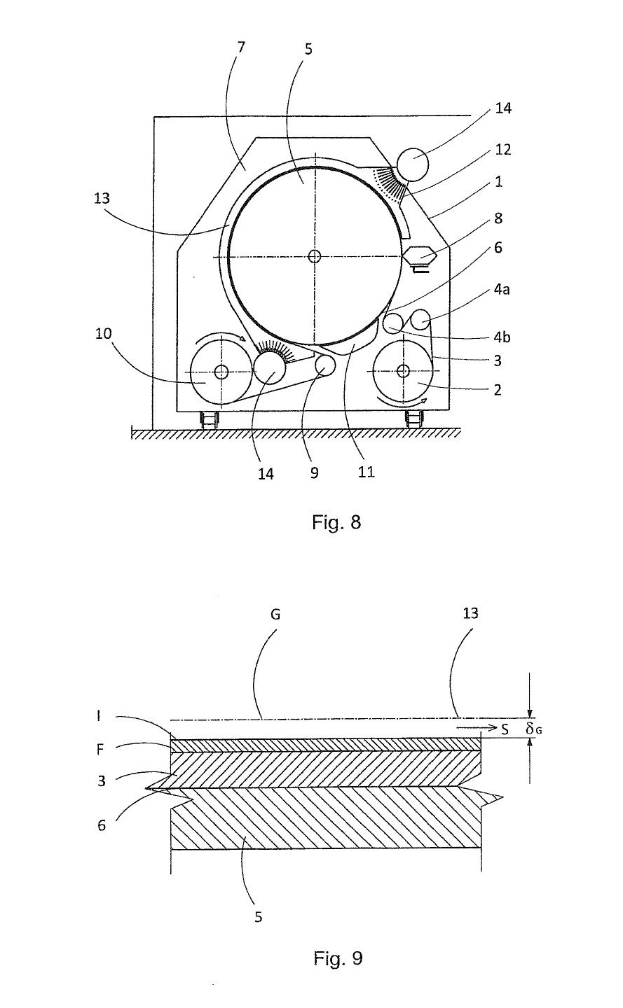

FIG. 8 shows a schematic sectional view through an exemplary embodiment of a drying device,

FIG. 9 shows a schematic detailed view according to FIG. 8,

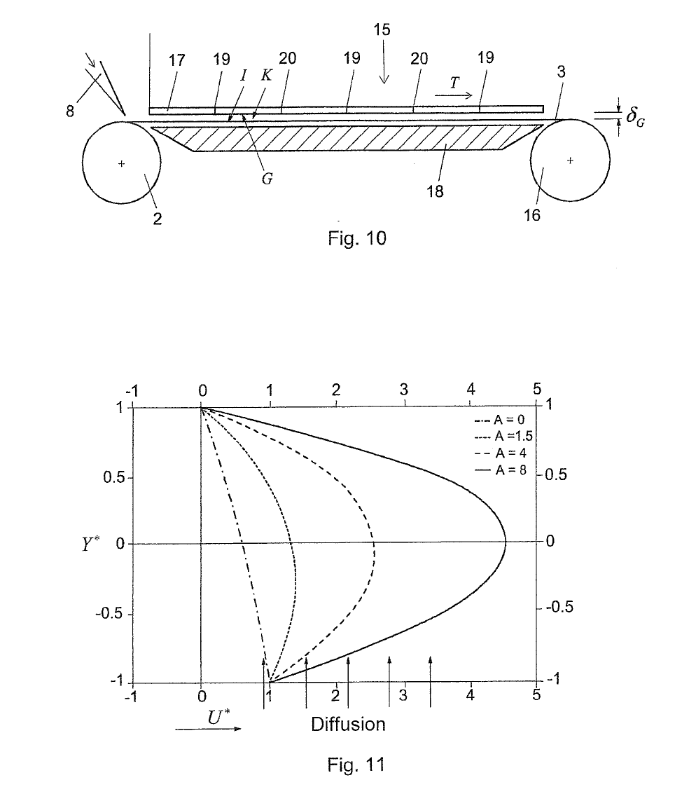

FIG. 10 shows a schematic sectional view through a further exemplary embodiment of a drying device,

FIG. 11 shows the speed of the transport gas over the distance between heating surface and substrate surface,

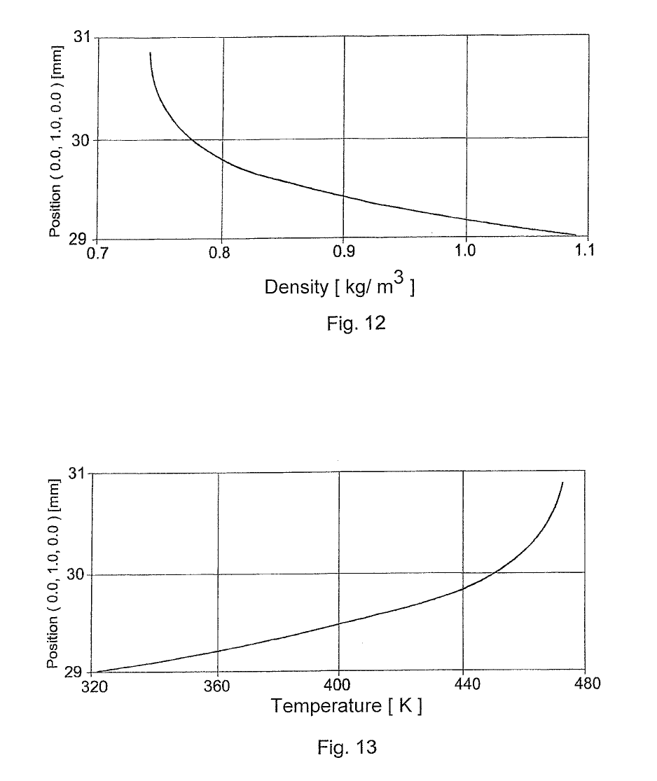

FIG. 12 shows the density of the transport gas over the distance between heating surface and substrate surface,

FIG. 13 shows the temperature of the transport gas over the distance between the heating surface and substrate surface, and

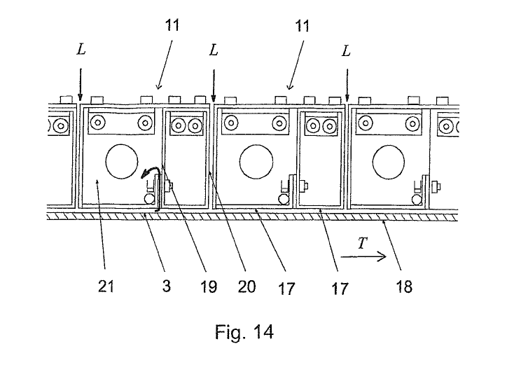

FIG. 14 shows a schematic sectional view through modules of a further drying device.

Theoretical principles of the method according to the invention will be explained briefly hereinafter on the basis of one-dimensional equations for the diffusive mass transport in accordance with temperature.

The variables used in the following equations are substantially apparent from FIG. 1.

The temperature gradient in the air gap above the boundary surface of the fluid film satisfies the energy equation which can be specified as follows for the gas phase:

$$\frac{{d}^{2} T}{d {y}^{2}} - ( \frac{\dot{m} {C}_{P}}{{λ}_{G}} ) \frac{d T}{d y} = 0$$

If this diffusion equation is solved, the following general solution is obtained:

$$T = {c}_{1} + {c}_{2} exp ( \frac{\dot{m} {C}_{P}}{{λ}_{G}} y ) ,$$

wherein c₁ and c₂ represent two integration constants yet to be defined. These can be determined via suitable boundary conditions. These boundary conditions are as follows:

$$y = 0 \frac{d T}{d y} {\vert}_{I / G} = \frac{( 1 - f ) * ( {T}_{H} - {T}_{I} )}{( \frac{{μ}_{G} Δ {h}_{LH}}{2 {T}_{I}} - {λ}_{G} ) * ( \frac{H}{{λ}_{S}} + \frac{h}{{λ}_{L}} )}$$

$$y = {δ}_{G} , \\ T = {T}_{G}$$

if the above equations are solved by using the boundary conditions according to c₁ and c₂, values are obtained for these variables that make it possible to specify the temperature profile in the gas phase as follows:

$$T = {T}_{G} - \frac{( 1 - f ) * ( {T}_{H} - {T}_{I} ) * \{ exp ( \frac{\dot{m} {C}_{P}}{{λ}_{G}} {δ}_{G} ) - exp ( \frac{\dot{m} {C}_{P}}{{λ}_{G}} y ) \}}{\dot{m} Cp * ( \frac{{μ}_{G} Δ {h}_{LH}}{2 {λ}_{G} {T}_{I}} - 1 ) * ( \frac{H}{{λ}_{S}} + \frac{h}{{λ}_{L}} )}$$

T=T₁ is obtained for y=0. The boundary surface temperature T₁, that is to say the temperature at the free surface of the fluid film, can thus be calculated as follows:

$${T}_{I} = {T}_{G} - \frac{( 1 - f ) * ( {T}_{H} - {T}_{I} ) * \{ exp ( \frac{\dot{m} {C}_{P}}{{λ}_{G}} {δ}_{G} ) - 1 \}}{\dot{m} Cp * ( \frac{{μ}_{G} Δ {h}_{LH}}{2 {λ}_{G} {T}_{I}} - 1 ) * ( \frac{H}{{λ}_{S}} + \frac{h}{{λ}_{L}} )}$$

The mass diffusion rate per unit of area can be calculated as follows on the basis of the temperature gradient present at the free surface:

$$\dot{m} = \frac{( 1 - f ) * {μ}_{G} * ( {T}_{H} - {T}_{I} )}{( {μ}_{G} Δ {h}_{LH} - 2 {λ}_{G} {T}_{I} ) * ( \frac{H}{{λ}_{S}} + \frac{h}{{λ}_{L}} )}$$

The drying time for the material to be coated can be calculated as follows:

$$\begin{matrix}{t}_{d} = \frac{M}{\dot{m}} \\ = \frac{{ρ}_{L} * h * ( {μ}_{G} Δ {h}_{LH} - 2 {λ}_{G} {T}_{I} ) * ( \frac{H}{{λ}_{S}} + \frac{h}{{λ}_{L}} )}{( 1 - f ) * {μ}_{G} * ( {T}_{H} - {T}_{I} )}\end{matrix}$$

Due to the above set of equations, the one-dimensional diffusion heat transfer problem and the problem of the associated mass release and of mass transport can be solved analytically.

With use of the boundary conditions described hereinafter, the mass diffusion rate of the vaporised liquid and the drying time were calculated inter alia. The calculation is performed under the following assumptions:

H=300 μm, h=10 μm, δ_{G}=300 μm
f=0.2, T_{G}=350 K, T_{H}=295 K

The following material properties were assumed to be constant, in spite of the temperature changes:

μ_{G}=1.8×10⁻⁵ kg/(ms), λ_{G}=0.024 W/(mK), C_{P}=1.012 KJ/(KgK)
λ_{L}=0.6 W/(mK), ρ_{L}=1000 kg/m³, Δh_{LH}=2260 KJ/Kg

### λ_{S}=0.12 W/(mK)

The drying of the fluid film is determined inter alia by a check of the second temperature T_{H} on the transport surface and by the first temperature T_{G} of the heat source. The heat source is fitted at a distance δ_{G} from the boundary surface of the fluid film facing the gas phase.

FIG. 2 shows the boundary surface temperature T_{I} over the first temperature T_{G} of the heat source or gas phase. FIG. 3 shows the boundary surface temperature T_{I} over the temperature T_{H} of the transport surface.

As can be seen in particular from FIGS. 3 to 5, the mass diffusion rate can be achieved by an increase of the first temperature T_{G}. It can also be seen that an increase of the second temperature T_{H} causes a reduction of the mass diffusion rate.

As can be seen in particular from FIGS. 6 and 7, a reduction of the drying time can then be achieved when the second temperature T_{H} is selected to be small and the first temperature T_{G} is selected to be high. Here, both temperatures T_{G} and T_{H} can be adjusted, such that T_{I} can be controlled. T_{I} can be held at room temperature, for example.

FIG. 8 shows a schematic sectional view of an exemplary embodiment of a drying device. A storage drum 2 is located in a housing 1, on which storage drum the substrate 3 to be coated is received. The substrate 3 is guided via first tension rollers 4a, 4b onto a transport cylinder 5. An outer lateral or transport surface 6 of the transport cylinder 5 is surrounded in portions, preferably over an angle of 180-270°, by a drying assembly 7. Upstream of the drying assembly 7, a slot die tool, denoted by reference sign 8, is provided in order to apply a fluid film F to the substrate 3. Downstream of the drying assembly 7, at least one further tension roller 9 is located, via which the substrate 3 is wound onto a cylinder 10. Reference sign 11 denotes a drum cleaning drum, which is arranged downstream of the drying assembly 7 and upstream of the slot die tool 8.

The drying assembly 7 has a further housing 12. The further housing 12 is provided with suction assemblies 14, by means of which a liquid vapour escaping from the fluid film F is sucked up.

In FIG. 9 a heat source 13 is formed for example from resistance heating wires. A heating surface G of the heat source 13 is arranged at a distance δ_{G} from for example 0.1 mm to 1.0 mm opposite the boundary surface I of the fluid film F. A flow direction of the transport gas running substantially parallel to the boundary surface I is indicated by the arrow S.

The device according to the invention shown in FIG. 8 is particularly compact. Instead of a transport drum 5, a plurality of transport drum 5 can also be used. A drying section can thus be enlarged, which also enables drying of relatively thick fluid films F.

FIG. 10 shows a schematic sectional view through a further exemplary embodiment of a diffusion dryer according to the invention or a further drying assembly 15. Here, the substrate 3 is again received on a storage drum 2; it is transported via a driven drum 16. Reference sign 8 again denotes a slot die tool for applying a fluid film F to the substrate 3, said tool being arranged upstream of a further drying assembly 15.

The further drying assembly 15 comprises a plurality of heating elements 17 arranged in succession in the transport direction T, said heating elements possibly being plate-shaped resistance heating elements. A heating surface G of the heating elements 17 is arranged at a distance δ_{G} from 2 to 10 mm from a substrate surface. Reference sign 18 denotes a further transport surface. The further transport surface 18 can be heatable. In particular, a predefined heating profile can be adjusted along the further transport surface 18. The further transport surface 18 can also be cooled.

Discharge openings 19 and feed openings 20 are provided alternately between the heating elements 17. The discharge openings 19 and/or feed openings 20 are expediently formed in a slot-like manner. In particular, the feed openings 20 can be provided with a flow-guiding assembly (not shown here). The flow-guiding assembly is formed such that the transport gas is fed to the drying channel in a direction that is substantially parallel to the boundary surface I.

In the case of the method according to the invention, the fluid film is dried not only by diffusion, but also by the convection of the transport gas in the drying channel. FIG. 11 shows the speed U* (dimensionless) over the distance Y* (dimensionless) between the heating surface and the substrate surface for various pressure gradients A (dimensionless). It is assumed that the transport surface moves to the right with a dimensionless speed U*=1. In the case of a pressure gradient A=0, a flow speed of 0 is produced in the region of the heating surface. The flow speed increases linearly in the direction of the transport surface to the value “1”. With increasing pressure gradient, that is to say with increasing flow speed of the transport gas in the transport direction, the flow speed increases. It is maximal at approximately half distance between heating surface and transport surface.

FIG. 12 shows the density of the transport gas over the distance between heating surface and substrate surface. The density increases with decreasing distance from the substrate surface due to the increasing content of vaporised liquid.

FIG. 13 shows the temperature of the transport gas over the distance between heating surface and substrate surface, wherein an entry temperature of the transport gas into the drying channel is approximately 475 K. As can be seen from FIG. 13, the temperature in this case decreases to a value of approximately 320 K in the region of the substrate surface.

FIG. 14 shows a schematic partial sectional view through a further device for drying. Two successive heating elements 17 are in each case part of a module M. A discharge opening 19 is provided in the form of a slot between the two heating surfaces G and opens out into a discharge channel 21. The discharge channels 21 of the modules M lead into a discharge collecting channel (not shown here), with which moist transport gas is fed to a dryer (not shown here).

A feed opening 20 for feeding transport gas, for example air L, is formed in each case between two modules arranged one after the other in the transport direction T. The feed openings 20 are also formed in a slot-like manner. A slot width of the feed openings 20 is larger than a slot width of the discharge openings 19. It is expediently twice, preferably 3 to 5 times, a slot width of the discharge openings 19.

### LIST OF REFERENCE SIGNS

1 housing
2 storage cylinder
3 substrate
4a, 4b tension roller
5 transport cylinder
6 transport surface
7 drying assembly
8 slot die tool
9 further tension roller
10 drum
11 drum cleaning device
12 further housing
13 heat source
14 suction assembly
15 further drying assembly
16 driven drum
17 heating element
18 further transport surface
19 discharge opening
20 feed opening
21 discharge channel
δ_{G} distance
F fluid film
G heating surface
I boundary surface
L air
M module
S flow direction
T transport direction

1. A method for drying a fluid film applied to a substrate surface of a substrate, the fluid film containing a vaporisable liquid, said method comprising the following steps:
transporting the substrate on a transport surface of a transport device along a transport direction through a drying assembly,
vaporising the liquid by means of a plurality of heat sources arranged in succession in the transport direction, wherein each of the heat sources has a heating surface, which is arranged at a distance from 0.1 mm to 15.0 mm opposite the substrate surface, and
discharging the vaporised liquid through a discharge opening provided between two successive heating surfaces.

2. The method according to claim 1, wherein transport gas is fed through a feed opening provided between two successive heating surfaces.

3. The method according to claim 1, wherein the transport gas is discharged and fed alternately in the transport direction through alternately arranged discharge openings and feed openings.

4. The method according to claim 1, wherein the transport gas is fed through the feed openings at a rate from 1 to 10 m/s.

5. The method according to claim 1, wherein the transport gas is heated, prior to being fed, to a temperature from 50° C. to 300° C., preferably 100° C. to 250° C.

6. The method according to claim 1, wherein the transport gas used is air, nitrogen or carbon dioxide.

7. The method according to claim 1, wherein a first temperature T_{G} of the heating surface is controlled depending on a boundary surface temperature T_{I} of the fluid film.

8. The method according to claim 1, wherein the first temperature T_{G} is controlled in the range from 50° C. to 200° C., preferably in the range between 80° C. and 150° C.

9. The method according to claim 1, wherein the heat of the heating surface is transferred to the fluid film substantially by means of direct heat conduction.

10. The method according to claim 1, wherein the transport surface is heated by means of a further heat source.

11. The method according to claim 1, wherein a second temperature T_{H} of the transport surface produced by the further heat source is controlled depending on the boundary surface temperature T_{I}.

12. The method according to claim 1, wherein the second temperature T_{H} is controlled such that the following relationship is satisfied:
T_{H}=T_{I}+ΔT, wherein
T_{I} lies in the range from 5° C. to 40° C. and
ΔT lies in the range from 2 to 30° C., preferably 5 to 10° C.

13. The method according to claim 1, wherein the heating surface facing the substrate is arranged at a distance from 0.2 mm to 10.0 mm opposite the substrate surface.

14. The method according to claim 1, wherein the second temperature T_{H} is controlled such that it is always less than the first temperature T_{G}.

15. The method according to claim 1, wherein a temperature difference between the first temperature T_{G} and the second temperature T_{H} is controlled such that a predefined temperature difference profile is set along the transport direction.

16. The method according to claim 1, wherein an electric heating source is used as heat source.

17. The method according to claim 1, wherein a heat exchanger is used as heat source.

18. The method according to claim 1, wherein at least one rotatable cylinder is used as transport device, the outer lateral surface of which forms the transport surface.

19. A device for drying a fluid film applied to a substrate surface of a substrate, the fluid film containing a vaporisable liquid, said device comprising:
a transport device for transporting the substrate on a transport surface along a transport direction,
a plurality of heat sources arranged opposite the substrate in succession in the transport direction, wherein each of the heat sources has a heating surface which is arranged at a distance from 0.1 to 15.0 mm opposite the substrate surface, and
an assembly for discharging the vaporised liquid, said assembly comprising a discharge opening provided between two successive heating surfaces for discharging the vaporised liquid.

20. The device according to claim 19, wherein an assembly for feeding transport gas is provided and comprises a feed opening provided between two successive heating surfaces for feeding the transport gas.

21. The device according to claim 19, wherein the discharge openings and feed openings are provided alternately between the heating surfaces arranged in succession in the transport direction.

22. The device according to claim 19, wherein the transport gas is fed through the feed openings at a rate of 1 to 10 m/s by means of the feeding assembly.

23. The device according to claim 19, wherein a heater for heating the transport gas to a temperature from 50° C. to 300° C., preferably 150° C. to 250° C., is provided.

24. The device according to claim 19, wherein the discharging device is formed from a plurality of modules arranged in succession in the transport direction, wherein each of the modules has two heating surfaces and a discharge opening provided therebetween, which is arranged upstream of a discharge channel.

25. The device according to claim 19, wherein two successive modules are arranged such that the feed opening is formed therebetween.

26. The device according to claim 19, wherein a feed channel and a fan for feeding the transport gas are provided upstream of the feed opening.

27. The device according to claim 19, wherein a further heat source for heating the transport surface is provided.

28. The device according to claim 19, wherein a first control assembly for controlling a first temperature T_{G} produced by the heating surface depending on a boundary surface temperature T_{I} of the fluid film is provided.

29. The device according to claim 19, wherein a second control device for controlling a second temperature T_{H} of the transport surface depending on the boundary surface temperature T_{I} is provided.

30. The device according to claim 19, wherein a temperature difference between the first temperature T_{G} and the second temperature T_{H} is controlled by means of the first and/or second control assembly such that a predefined temperature difference profile is set along the transport direction.

31. The device according to claim 19, wherein an assembly for flushing a housing surrounding the transport device with a non-combustible gas, preferably nitrogen or carbon dioxide atmosphere, is provided.

32. The device according to claim 19, wherein the heating surface facing the substrate is arranged at a distance from 0.2 mm to 10.0 mm opposite the substrate surface.

33. The device according to claim 19, wherein the heat source is an electric heat source.

34. The device according to claim 19, wherein the heat source is a heat exchanger.

35. The device according to claim 19, wherein the transport device comprises a rotatable drum the outer lateral surface of which forms the transport surface.
